(19) United States
(12) Patent Application Publication
(10) Pub. No.: US 2009/0141169 A1
(43) Pub. Date: Jun. 4, 2009

(54) SUBLIMINAL IMAGE SYSTEM

(75) Inventors: Graham Whale Smith, Reading (GB); Andrew Gordon Hassan, Reading (GB)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: THE SECRETARY OF STATE FOR DEFENCE, LONDON (GB)

(21) Appl. No.: 12/302,043

(22) PCT Filed: May 24, 2007
(86) PCT No.: PCT/GB2007/001940

§ 371 Date: Nov. 24, 2008

(30) Foreign Application Priority Data
May 26, 2006 (GB) 0610466.5

(51) Int. Cl. H04N 5/04

(52) U.S. Cl. 348/500; 348/E05.009

(57) ABSTRACT

A Subliminal Image System is described whereby a subliminal image, data set or message is transmitted by simple flashing light sources and captured by a camera system.

The current invention relates to subliminal imaging. In particular the present invention relates to a system for transmitting and reading a subliminal image, where that image corresponds to data, a picture or a message.

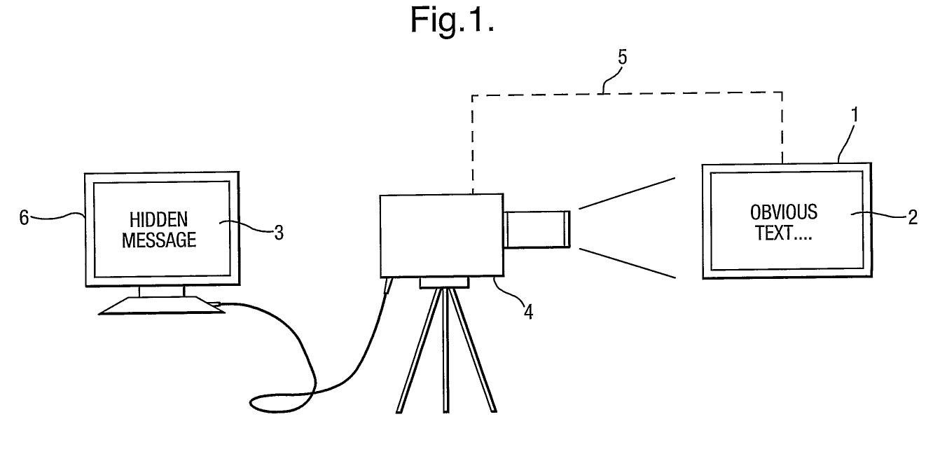

A previous subliminal messaging system has been shown (FIG. 1) in which an electronic message board or display panel or TV display (1) has been able to display a message or image visible to the human eye (2), but which momentarily displays a subliminal message (3) undetectable by the human eye, which is picked up by a camera system (4) which is synchronised by means of a synchronising link (5) with occurrence of the subliminal message. The subliminal message picked up by the camera system is then displayed on a TV monitor (6) which effectively shows a ‘still’ of the subliminal message (3), although this can of course be updated as often as a subliminal message is shown on the electronic message board or display panel or TV display.

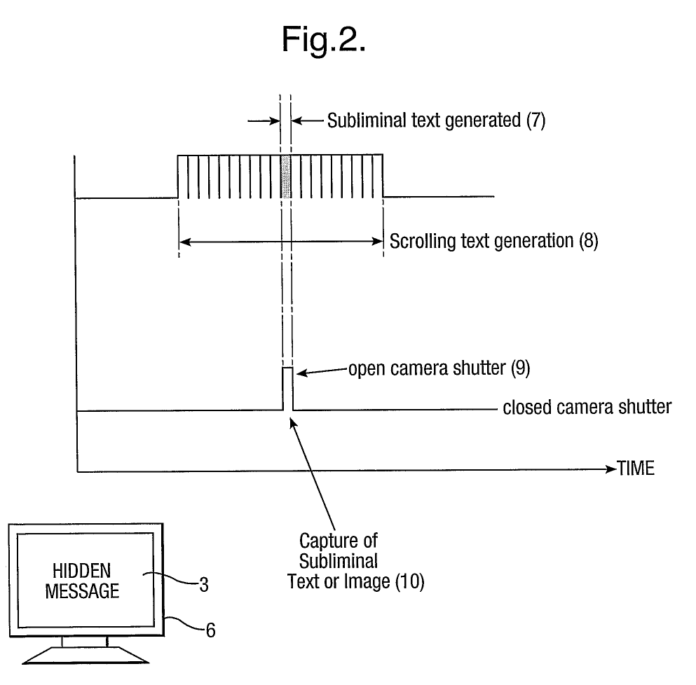

FIG. 2 shows a timing diagram indicating how the subliminal message display occurs for one frame (7) during a more general scrolling text generation sequence (8), at which time a shutter in the camera system is open (9) to capture the subliminal message (10, 3)

The problem with the prior art is that reading a detailed subliminal message in this way is not easy in a situation where it is necessary to quickly pick up a subliminal message from, for example, a moving source. In such an instance, the focussing and directing of a camera to clearly view a subliminal message that is shown for a very short period of time presents a problem.

The current invention is directed towards a system for picking out a subliminal image from simple flashing light sources.

Accordingly, there is provided a subliminal image system comprising at least two light sources (11) each having an on state and an off state, a timing driver (12) to control the on and off states of the light sources, a camera system (4) and a synchronising means (5), characterised in that the timing driver (12) causes the light sources (11) to flash on and off in different phases so as to cause a phase difference period (14) during which a subliminal image (13) undetectable to the human eye, caused by the different phases of the light sources, is displayed by the light sources, and during which phase difference period the camera system (4) is activated by the synchronising means (5) so that the subliminal image is captured by the camera system (4).

The current invention is a subliminal image system primarily directed towards the ready transmission and receipt of a subliminal image by means of flashing lights, where that image corresponds to data, a picture or a message.

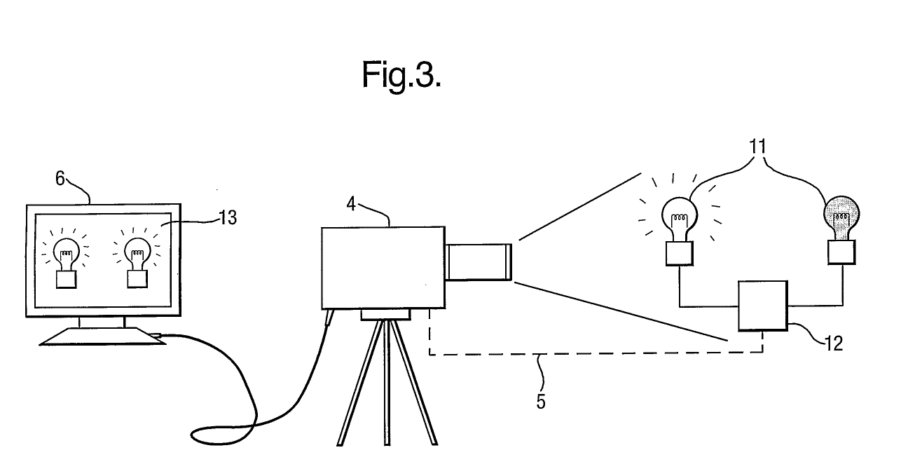

By way of example (FIG. 3), a pair of light sources (11) constitute a single pair of flashing lights. Preferably LEDs or arrays or clusters of LEDs would be used as the light sources in accordance with this embodiment of the invention, as LEDs are able to switch on and off very quickly with little residual glow in transition from one state to the other. These light sources (11) are powered and driven through a timing driver (12). The camera system (4) is sited so as to have a view of the light sources (11), and a readout monitor (6) is arranged so as to show images (13) captured by the camera system (4).

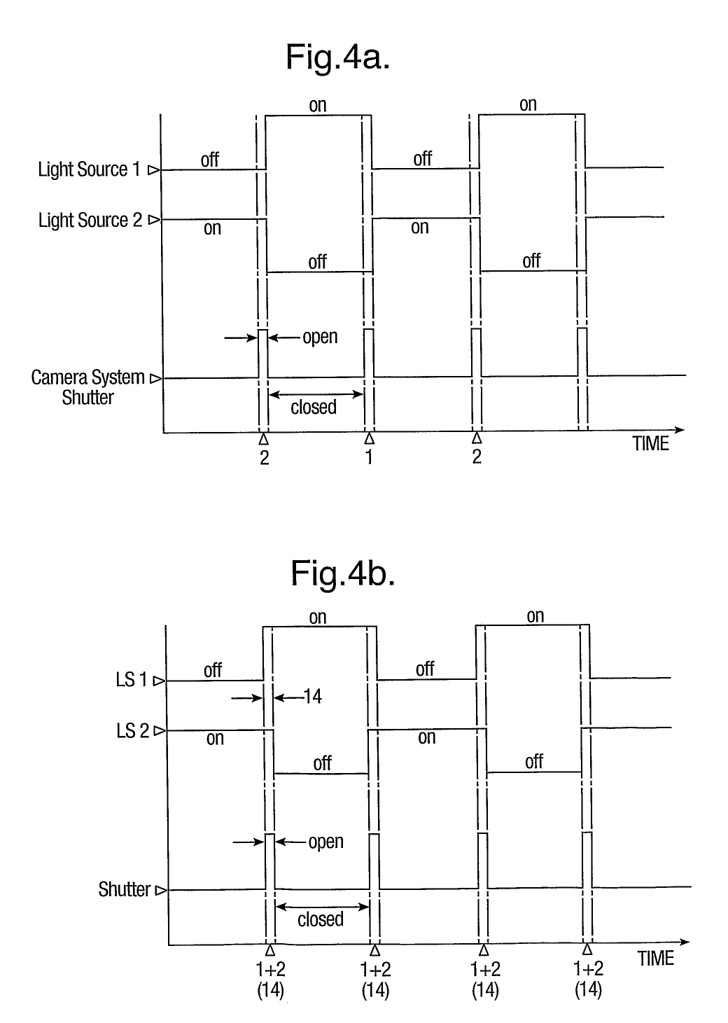

FIGS. 4a and 4b show timing diagrams of the subliminal image system. If the subliminal image system is activated (FIG. 4b), the two light sources will have a phase difference period (14) such that the light sources exhibit a timing overlap in their ‘on’ or ‘off’ phase, for a period of time undetectable by the human eye. In this example the lights appear to the human eye to be flashing on and off alternately, such that when one light source is ‘on’, the other is ‘off’, and vice versa. However, there is an overlap in the ‘on’ phase. To the human eye, the light sources appear to be flashing on and off alternately. The camera system, which is synchronised with the flashing lights by means of the synchronising means (5), will capture an image (13) during that period of time where both light sources are in their ‘on’ phase, and the readout monitor will therefore show an image where both clusters are ‘on’ (13). This image represents the subliminal image or message.

If however the subliminal image system is not activated (FIG. 4a), the light sources have no overlap in their ‘on’ or ‘off’ phase, and the light sources appear to be flashing on and off alternately both to the human eye and in the images captured by the camera system. In this mode, there is no image where both light sources are ‘on’, and this represents an absence of the subliminal image or message.

The synchronising means in the subliminal image system, by which the camera system is able to take an image in the phase difference period of the flashing lights, may be any means familiar to those skilled in the art, and may comprise a direct physical link, a radio signalling means, a simultaneous timing element common to the timing driver and camera system, a further element in the timing driver and camera system which uses some commonly available signal in order to set timing for the system, initial image processing of the image of the flashing lights to pick up the overlap or phase difference of the light sources flashing, or any other means.

The example given above is one of the simpler embodiments of the system, utilising a single pair of alternately flashing lights in which can be hidden the subliminal image. It can readily be seen that any number of flashing light sources, with suitable timing overlaps, can similarly be used to give a number of possible patterns of display in the subliminal overlap period which can in turn relate to one of a number of pre-arranged messages or identification markers.

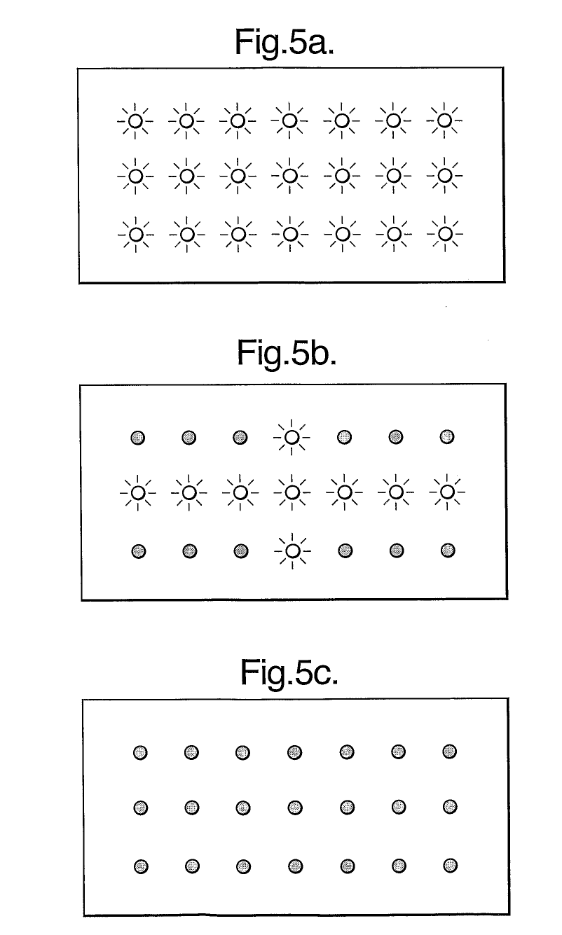

By way of example, FIG. 5 shows a further specific embodiment of the invention, a display matrix of a seven by three ‘grid’ of light sources, in this example LEDs, which is seen by the naked eye to be switching on and off. However, in between the ‘all LEDs on’ (FIG. 5a) and ‘all LEDs off’ (FIG. 5c) phases, a specially selected pattern of LEDs momentarily remains ‘on’ (FIG. 5b), and the camera system, synchronised by the synchronising means to this phase difference period, captures an image of this pattern, which occurs too briefly for the human eye to see. This image, if desired, can then be displayed on a readout monitor. Advantageously, using an array or grid of light sources in this way means that a subliminal image that is an icon or alpha numeric or other recognisable or pre-programmed pattern, momentarily displayed on a light source ‘grid’, can be hidden in what appears to the casual observer to be a simple group of light sources switching on and off together, but picked up by a camera system synchronised with the phase difference period. This image can then if desired be displayed to an observer.

It can readily be seen that the above example is a representative embodiment only, and that any size of light source array or grid may be utilised. Advantageously, the larger the grid, the more complex or sophisticated a subliminal image may be displayed, which can thus transmit proportionally more information the larger the grid becomes. In this way, for example, a grid of twenty by ten LEDs can readily be appreciated to present much more scope in terms of the possible display than the previous seven by three grid example.

In a different embodiment of the invention, a subliminal image or subliminal identifying marker is created by a subliminal image system utilising a single light source. There is provided a subliminal image system comprising at least one light source having an on phase and an off phase, a timing driver to control the on and off states of the light source, and a camera system having a defined frame per second rate, characterised in that the timing driver causes the light source to flash on and off at a controlled phase rate relative to the frame per second rate of the camera system such that over a defined time period, which is a multiple of the frame per second rate of the camera system, the first and last frame images of the light source captured by the camera system may either be the same or different and thus either comprise a message of themselves or indicate the presence of a further subliminal message.

Advantageously, this variation requires no synchronising link between the timing driver and the camera system.

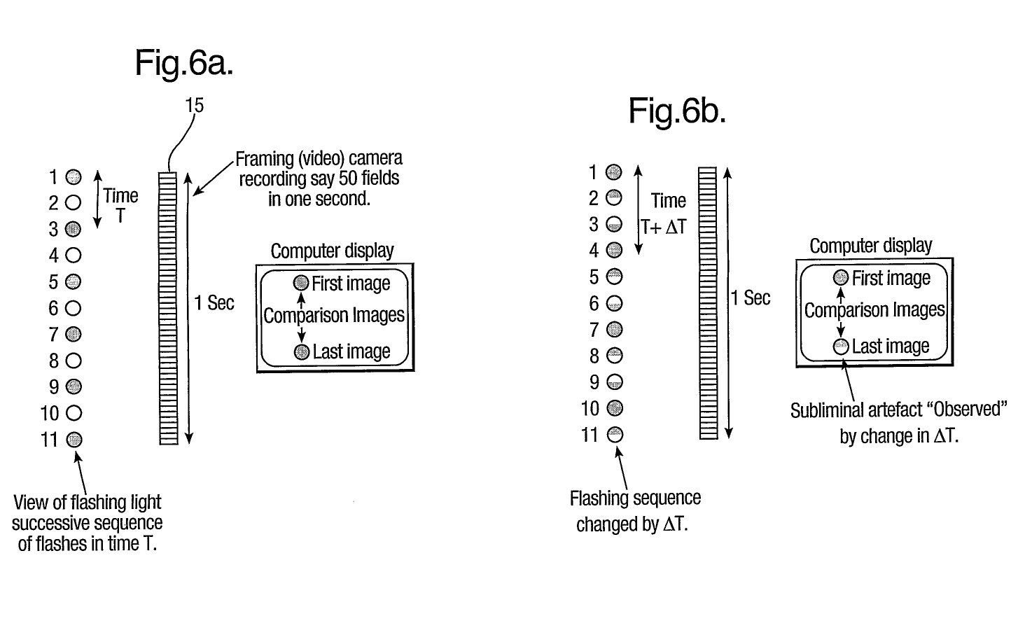

By way of example of this variation, in a specific embodiment of the invention (FIG. 6), a camera system has a 50 frame per second image capture rate (15) and has a view of a light source. When the light source is flashing on and off with a time duration T (FIG. 6a), the light source image captured by the camera system in the first frame is identical in terms of phase of the light source to the image of the light source captured by the 50^{th} frame. If the light source is flashing on and off with a time duration changed from T by a small percentage ΔT which is not an integer sub-multiple of the framing rate, the first and 50^{th} frame images of the light source will show the light source in different phases (FIG. 6b).

The frame images may be displayed on a readout monitor for visual comparison by a human observer, or comparison of frame images may advantageously be done by image processing in order to quickly identify the presence or absence of a subliminal message or subliminal message marker.

The fact that the 1^{st} and 50^{th} images are the same or different may of itself have a meaning or may simply indicate that there is a further subliminal message being transmitted.

Note that if the light source is simply flashing on and off, the first and 50^{th} frame images may differ in one being on and one off, or by differing in intensity as the light source transitions between its on and off states.

However, as well as a light source that remains essentially static but which switches between on and off states, the light source may consist of a constantly light-emitting element backed by an opaque object which is rotating such that from the point of view of the camera system or to the general observer the light source appears to wax and wane. Frame images may then show the light source at different points in its rotation.

Clearly, multiple frame images, not just the first and 50^{th}, may be made the subject of comparison, especially if some form of image processing is being employed, thus potentially providing a further marker to check against expected image phases and indicate the presence or otherwise of a subliminal message or alternately thus form a subliminal message or part of a subliminal message of themselves.

### Subliminal Image System

The current invention relates to subliminal imaging. In particular the present invention relates to a system for transmitting and reading a subliminal image, where that image corresponds to data, a picture or a message.

A previous subliminal messaging system has been shown (FIG. 1) in which an electronic message board or display panel or TV display (1) has been able to display a message or image visible to the human eye (2), but which momentarily displays a subliminal message (3) undetectable by the human eye, which is picked up by a camera system (4) which is synchronised by means of a synchronising link (5) with occurrence of the subliminal message. The subliminal message picked up by the camera system is then displayed on a TV monitor (6) which effectively shows a ‘still’ of the subliminal message (3), although this can of course be updated as often as a subliminal message is shown on the electronic message board or display panel or TV display. FIG. 2 shows a timing diagram indicating how the subliminal message display occurs for one frame (7) during a more general scrolling text generation sequence (8), at which time a shutter in the camera system is open (9) to capture the subliminal message (10, 3)

The problem with the prior art is that reading a detailed subliminal message in this way is not easy in a situation where it is necessary to quickly pick up a subliminal message from, for example, a moving source. In such an instance, the focussing and directing of a camera to clearly view a subliminal message that is shown for a very short period of time presents a problem.

The current invention is directed towards a system for picking out a subliminal image from simple flashing light sources.

Accordingly, there is provided a subliminal image system comprising at least two light sources (11) each having an on state and an off state, a timing driver (12) to control the on and off states of the light sources, a camera system (4) and a synchronising means (5), characterised in that the timing driver (12) causes the light sources (11) to flash on and off in different phases so as to cause a phase difference period (14) during which a subliminal image (13) undetectable to the human eye, caused by the different phases of the light sources, is displayed by the light sources, and during which phase difference period the camera system (4) is activated by the synchronising means (5) so that the subliminal image is captured by the camera system (4).

The current invention is a subliminal image system primarily directed towards the ready transmission and receipt of a subliminal image by means of flashing lights, where that image corresponds to data, a picture or a message.

By way of example (FIG. 3), a pair of light sources (11) constitute a single pair of flashing lights. Preferably LEDs or arrays or clusters of LEDs would be used as the light sources in accordance with this embodiment of the invention, as LEDs are able to switch on and off very quickly with little residual glow in transition from one state to the other. These light sources (11) are powered and driven through a timing driver (12). The camera system (4) is sited so as to have a view of the light sources (11), and a readout monitor (6) is arranged so as to show images (13) captured by the camera system (4).

FIGS. 4a and 4b show timing diagrams of the subliminal image system. If the subliminal image system is activated (FIG. 4b), the two light sources will have a phase difference period (14) such that the light sources exhibit a timing overlap in their ‘on’ or ‘off’ phase, for a period of time undetectable by the human eye. In this example the lights appear to the human eye to be flashing on and off alternately, such that when one light source is ‘on’, the other is ‘off’, and vice versa. However, there is an overlap in the ‘on’ phase. To the human eye, the light sources appear to be flashing on and off alternately. The camera system, which is synchronised with the flashing lights by means of the synchronising means (5), will capture an image (13) during that period of time where both light sources are in their ‘on’ phase, and the readout monitor will therefore show an image where both clusters are ‘on’ (13). This image represents the subliminal image or message.

If however the subliminal image system is not activated (FIG. 4a), the light sources have no overlap in their ‘on’ or ‘off’ phase, and the light sources appear to be flashing on and off alternately both to the human eye and in the images captured by the camera system. In this mode, there is no image where both light sources are ‘on’, and this represents an absence of the subliminal image or message.

The synchronising means in the subliminal image system, by which the camera system is able to take an image in the phase difference period of the flashing lights, may be any means familiar to those skilled in the art, and may comprise a direct physical link, a radio signalling means, a simultaneous timing element common to the timing driver and camera system, a further element in the timing driver and camera system which uses some commonly available signal in order to set timing for the system, initial image processing of the image of the flashing lights to pick up the overlap or phase difference of the light sources flashing, or any other means.

The example given above is one of the simpler embodiments of the system, utilising a single pair of alternately flashing lights in which can be hidden the subliminal image. It can readily be seen that any number of flashing light sources, with suitable timing overlaps, can similarly be used to give a number of possible patterns of display in the subliminal overlap period which can in turn relate to one of a number of pre-arranged messages or identification markers.

By way of example, FIG. 5 shows a further specific embodiment of the invention, a display matrix of a seven by three ‘grid’ of light sources, in this example LEDs, which is seen by the naked eye to be switching on and off. However, in between the ‘all LEDs on’ (FIG. 5a) and ‘all LEDs off’ (FIG. 5c) phases, a specially selected pattern of LEDs momentarily remains ‘on’ (FIG. 5b), and the camera system, synchronised by the synchronising means to this phase difference period, captures an image of this pattern, which occurs too briefly for the human eye to see. This image, if desired, can then be displayed on a readout monitor. Advantageously, using an array or grid of light sources in this way means that a subliminal image that is an icon or alpha numeric or other recognisable or pre-programmed pattern, momentarily displayed on a light source ‘grid’, can be hidden in what appears to the casual observer to be a simple group of light sources switching on and off together, but picked up by a camera system synchronised with the phase difference period. This image can then if desired be displayed to an observer.

It can readily be seen that the above example is a representative embodiment only, and that any size of light source array or grid may be utilised. Advantageously, the larger the grid, the more complex or sophisticated a subliminal image may be displayed, which can thus transmit proportionally more information the larger the grid becomes. In this way, for example, a grid of twenty by ten LEDs can readily be appreciated to present much more scope in terms of the possible display than the previous seven by three grid example.

In a different embodiment of the invention, a subliminal image or subliminal identifying marker is created by a subliminal image system utilising a single light source. There is provided a subliminal image system comprising at least one light source having an on phase and an off phase, a timing driver to control the on and off states of the light source, and a camera system having a defined frame per second rate, characterised in that the timing driver causes the light source to flash on and off at a controlled phase rate relative to the frame per second rate of the camera system such that over a defined time period, which is a multiple of the frame per second rate of the camera system, the first and last frame images of the light source captured by the camera system may either be the same or different and thus either comprise a message of themselves or indicate the presence of a further subliminal message.

Advantageously, this variation requires no synchronising link between the timing driver and the camera system.

By way of example of this variation, in a specific embodiment of the invention (FIG. 6), a camera system has a 50 frame per second image capture rate (15) and has a view of a light source. When the light source is flashing on and off with a time duration T (FIG. 6a), the light source image captured by the camera system in the first frame is identical in terms of phase of the light source to the image of the light source captured by the 50^{th} frame. If the light source is flashing on and off with a time duration changed from T by a small percentage ΔT which is not an integer sub-multiple of the framing rate, the first and 50^{th} frame images of the light source will show the light source in different phases (FIG. 6b).

The frame images may be displayed on a readout monitor for visual comparison by a human observer, or comparison of frame images may advantageously be done by image processing in order to quickly identify the presence or absence of a subliminal message or subliminal message marker.

The fact that the 1^{st} and 50^{th} images are the same or different may of itself have a meaning or may simply indicate that there is a further subliminal message being transmitted.

Note that if the light source is simply flashing on and off, the first and 50^{th} frame images may differ in one being on and one off, or by differing in intensity as the light source transitions between its on and off states.

However, as well as a light source that remains essentially static but which switches between on and off states, the light source may consist of a constantly light-emitting element backed by an opaque object which is rotating such that from the point of view of the camera system or to the general observer the light source appears to wax and wane. Frame images may then show the light source at different points in its rotation.

Clearly, multiple frame images, not just the first and 50^{th}, may be made the subject of comparison, especially if some form of image processing is being employed, thus potentially providing a further marker to check against expected image phases and indicate the presence or otherwise of a subliminal message or alternately thus form a subliminal message or part of a subliminal message of themselves.

1. A subliminal image system comprising at least two light sources each having an on state and an off state, a timing driver to control the on and off states of the light sources, a camera system and a synchronising means, wherein the timing driver causes the light sources to flash on and off in different phases so as to cause a phase difference period during which a subliminal image undetectable to the human eye, caused by the different phases of the light sources, is displayed by the light sources, and during which phase difference period the camera system is activated by the synchronising means so that the subliminal image is captured by the camera system.

2. A subliminal image system as claimed in claim 1, further comprising image processing means to automatically identify the subliminal image captured by the camera system.

3. A subliminal image system as claimed in claim 1, further comprising a readout monitor on which the subliminal image captured by the camera system may be displayed.

4. A subliminal image system as claimed in claim 1 where a plurality of light sources are arranged in an array and the subliminal image presented in the phase difference period takes the form of an alphanumeric or other recognisable symbol, or a pattern.

5. A subliminal image system comprising at least one light source having an on phase and an off phase, a timing driver to control the on and off states of the light source, and a camera system having a defined frame per second rate, wherein the timing driver causes the light source to flash on and off at a controlled phase rate relative to the frame per second rate of the camera system such that over a defined time period, which is a multiple of the frame per second rate of the camera system, the first and last frame images taken of the light source by the camera system may either be the same or different and thus either comprise a message of themselves or indicate the presence of a further subliminal message.

6. A subliminal image system as claimed in claim 5 further comprising an image processing means to automatically compare the frame images and automatically identify the presence or absence of a subliminal message or subliminal message indicator.

7. A subliminal image system as claimed in claim 5, where the light source or sources consist of a lighting element which is constantly on when in operation coupled with an opaque screen such that the lighting element and opaque screen rotate about an axis so that the lighting element appears from a fixed viewpoint to flash on and off.

8. A subliminal image system as claimed in claim 1, where the light sources or lighting elements consist of LEDs or arrays or clusters of LEDs.
